(19) United States
(12) Patent Application Publication
(10) Pub. No.: US 2009/0078517 A1
(43) Pub. Date: Mar. 26, 2009

(54) Damping force adjusting structure of hydraulic shock absorber

(75) Inventors: Noriaki Maneyama, Saitama (JP); Takashi Tsukahara, Saitama (JP); Seiryo Konakai, Saitama (JP)

Correspondence Address: Orum & Roth LLC, 53 W. Jackson Blvd., Chicago, IL, 60604-3606, US

(73) Assignee: SHOWA CORPORATION

(21) Appl. No.: 12/075,683

(22) Filed: Mar. 13, 2008

(30) Foreign Application Priority Data
Sep. 26, 2007 (JP) 2007-250079

(51) Int. Cl. F16F 9/14

(52) U.S. Cl. 188/314

(57) ABSTRACT

In a damping force adjusting structure of a hydraulic shock absorber, a blow valve blowing an oil liquid in a pressurized piston side chamber to a rod side chamber is provided in a bypass path communicating the rod side chamber and the piston side chamber while bypassing a damping valve, and the blow valve has a first pressure receiving portion which can receive the pressure of the piston side chamber before and after the valve opening, and a second pressure receiving portion which can receive the pressure of the piston side chamber after the valve opening.

### BACKGROUND OF THE INVENTION

1. Field of the Invention

The present invention relates to a damping force adjusting structure of a hydraulic shock absorber.

2. Description of the Related Art

For a damping force adjusting structure of a hydraulic shock absorber, there is a structure described in Japanese Patent Application Laid-Open (JP-A) No. 2000-110881 (patent document 1). The hydraulic shock absorber is structured such that an oil liquid is accommodated in an oil chamber of a cylinder, a piston provided in an insertion end of a piston rod inserted to the cylinder is slidably fitted and inserted to the cylinder, and a damping force is generated by controlling a flow of the oil liquid from one oil chamber pressurized by a sliding motion of the piston to the other oil chamber by a damping valve. Further, a damping force generated by the damping valve is adjusted by setting a bypass path bypassing the damping valve, and a free piston opening and closing the bypass path. The free piston is provided with an orifice, stops at a position dosing the bypass path so as to generate the damping force of the damping valve at a time when the frequency of a piston moving speed of the hydraulic shock absorber is low, and moves to a position opening the bypass path so as to reduce the damping force of the damping valve at a time when the frequency of the piston moving speed of the hydraulic shock absorber is high.

The damping force adjusting structure of the hydraulic shock absorber described in the patent document 1 is structured such as to control a damping force characteristic while depending upon the frequency of the piston moving speed of the hydraulic shock absorber. Accordingly, for example, when the stroke is inverted to an expansion stroke after the frequency of the piston moving speed becomes higher in a compression stroke of the hydraulic shock absorber, and the free piston moves to the position opening the bypass path so as to reduce the damping force, the free piston does not move from the position opening the bypass path if the frequency of the piston moving speed is low, so that it is impossible to generate a high damping force.

### SUMMARY OF THE INVENTION

An object of the present invention is to extremely lower damping force of a damping valve from a high damping force state during a high pressure period when a piston moving speed reaches a fixed speed, in a damping force adjusting structure of a hydraulic shock absorber.

The present invention relates to a damping force adjusting structure of a hydraulic shock absorber comprising an oil chamber of a cylinder accommodating an oil fluid/liquid therein, a piston slidably fitted and inserted to the cylinder, provided in an insertion end of a piston rod inserted to the cylinder, and a damping valve to control flow of an oil fluid/liquid from one oil chamber to the other oil chamber pressurized by a sliding motion of the piston so as to generate a damping force. A blow valve for blowing the oil fluid/liquid in the pressurized one oil chamber to the other oil chamber is provided in a bypass path communicating said both oil chambers while bypassing the damping valve. The blow valve having a first pressure receiving portion capable of receiving the pressure of the one oil chamber before and after the valve opening, and a second pressure receiving portion capable of receiving the pressure of the one oil chamber after the valve opening. The blow valve is provided with a differential pressure generating means lowering a pressure in a side communicating with the other oil chamber of said blow valve with respect to a pressure in a side communicating with the one oil chamber of said blow valve after the valve opening.

### BRIEF DESCRIPTION OF THE DRAWINGS

The present invention will be more fully understood from the detailed description given below and from the accompanying drawings which should not be taken to be a limitation on the invention, but are for explanation and understanding only.

FIG. 1 is a schematic cross sectional view showing a hydraulic shock absorber;

FIGS. 2A and 2B show a compression side damping force adjusting structure, in which FIG. 2A is a schematic cross sectional view and FIG. 2B is a schematic cross sectional view showing a variable orifice;

FIG. 3 is a graph showing a relation between piston speed and damping force;

FIG. 4 is a graph showing a result of adjusting the damping force;

FIG. 5 is a schematic cross sectional view showing a modified embodiment of the compression side damping force adjusting structure; and

FIG. 6 is a schematic cross sectional view showing an expansion side damping force adjusting structure.

### DESCRIPTION OF THE PREFERRED EMBODIMENTS

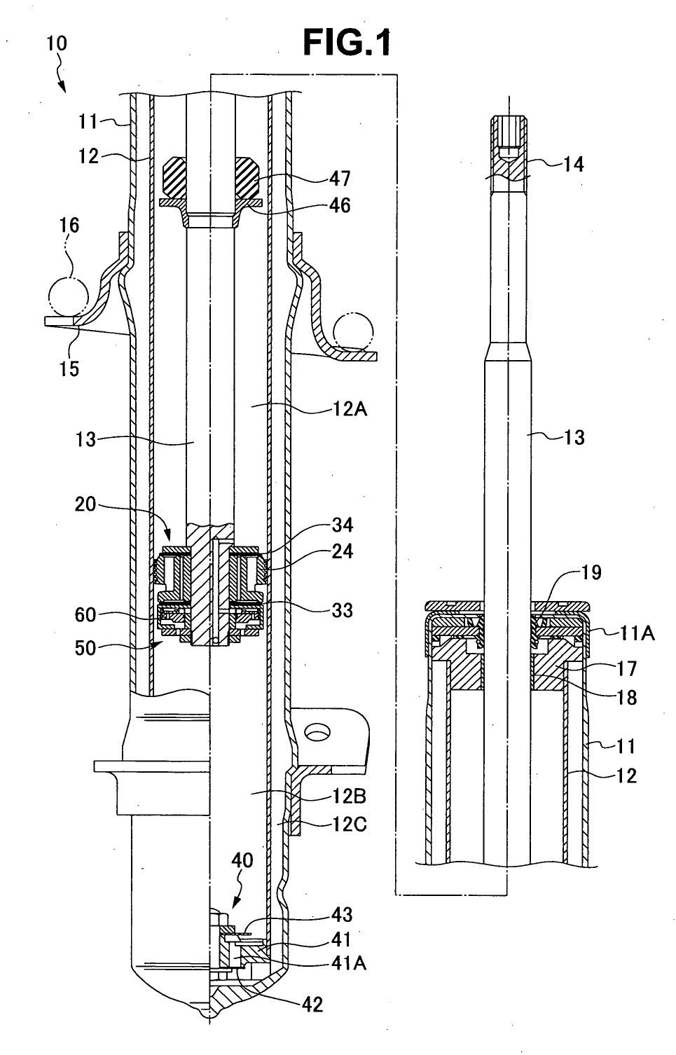

A damping force adjusting type hydraulic shock absorber 10 is of a double cylinder type in which a damper tube 11 has a cylinder 12 built-in, as shown in FIG. 1, and is structured such that a piston rod 13 is inserted to the cylinder 12 accommodating an oil liquid therein. An axle side attaching portion is provided in a lower portion of the damper tube 11, and a vehicle body side attaching portion 14 is provided in an upper portion of the piston rod 13, thereby constructing a suspension apparatus of a vehicle.

The hydraulic shock absorber 10 interposes a suspension spring 16 between a lower spring seat 15 in an outer periphery of the damper tube 11, and an upper spring seat (not shown) provided in the vehicle body side attaching portion 14 in the upper end portion of the piston rod 13.

The hydraulic shock absorber 10 pinches and fixes a rod guide 17, a bush 18 and an oil seal 19 for the piston rod 13 inserted to the cylinder 12 between an upper end caulking portion 11A of the damper tube 11 and an upper end portion of the cylinder 12.

The damping force adjusting type hydraulic shock absorber 10 has a piston valve apparatus 20 and a bottom valve apparatus 40. The piston valve apparatus 20 and the bottom valve apparatus 40 controls an oil liquid flow generated by a sliding motion of the cylinder 12 by a piston 24 mentioned below and is provided in an insertion end to the cylinder 12 of the piston rod 13 so as to generate a damping force, and controls a stretching vibration of the piston rod 13 caused by an absorption of an impact force by the suspension spring 16 on the basis of the damping force generated thereby.

### (Piston Valve Apparatus 20)

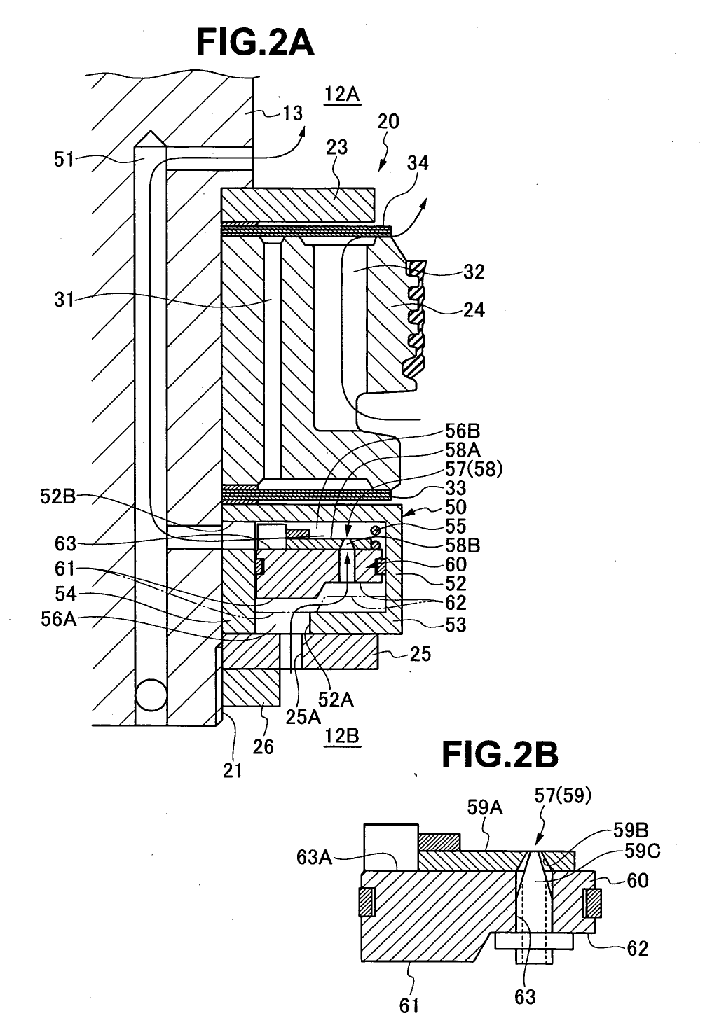

The piston valve apparatus 20 has a thread portion 21 in an outer periphery of an insertion end of the piston rod 13 to the cylinder 12, as shown in FIGS. 2A and 2B, and is structured such that a valve stopper 23, the piston 24, a valve case 52 for a blow valve 60 mentioned below and a spacer 25 are installed to an outer periphery of the thread portion 21, and are pinched and fixed with respect to a base end step portion of the thread portion 21 by a nut 26 screwed to the thread portion 21.

The piston 24 is slidably fitted and inserted to the cylinder 12, and is provided with an expansion side flow path 31 and a compression side flow path 32. An annular center portion of a disc valve shaped expansion side damping valve 33 is pinched between the piston 24 and the valve case 52, and an annular center portion of a disc valve shaped compression side damping valve 34 is pinched between the piston 24 and the valve stopper 23. In other words, the piston valve apparatus 20 compartmentalizes an inner side of the cylinder 12 into a rod side chamber 12A and a piston side chamber 12B by the piston 24. The rod side chamber 12A and the piston side chamber 12B are communicated respectively via the expansion side flow path 31 provided in the piston 24 and the expansion side damping valve 33 opening and closing the expansion side flow path 31, and the compression side flow path 32 and the compression side damping valve 34 opening and closing the compression side flow path 32.

Accordingly, during expansion, the oil in the rod side chamber 12A passes through the expansion side flow path 31 of the piston 24, deflection deforms the expansion side damping valve 33 so as to open, the oil is guided to the piston side chamber 12B and generates the expansion side damping force. Further, during compression, the oil in the piston side chamber 12B passes through the compression side flow path 32 of the piston 24, deflection deforms the compression side damping valve 34 so as to open, the oil is guided to the rod side chamber 12A and generates the compression side damping force.

### (Bottom Valve Apparatus 40)

The hydraulic shock absorber 10 is structured such that a reservoir chamber 12C is formed in a gap between the damper tube 11 and the cylinder 12, and an inner portion of the reservoir chamber 12C is compartmentalized into an oil chamber and a gas chamber. Further, the bottom valve apparatus 40 is structured such that a bottom piece 41 compartmentalizing a piston side chamber 12B and the reservoir chamber 12C in an inner portion of the cylinder 12 is arranged between a lower end portion of the cylinder 12 and a bottom portion of the damper tube 11. A space between the bottom portion of the damper tube 11 and the bottom piece 41 can be communicated with the reservoir chamber 12C by a flow path provided in the bottom piece 41.

The bottom valve apparatus 40 is provided with a disc valve 42 and a check valve 43 serving as bottom valves respectively opening and closing a compression side flow path 41A and an expansion side flow path (not shown) provided in the bottom piece 41.

Further, during expansion, an oil at a retracting volumetric capacity of the piston rod 13 retracting from the cylinder 12 pushes open the check valve 43, and is supplied to the piston side chamber 12B via the expansion side flow path (not shown) of the bottom piece 41 from the reservoir chamber 12C. During compression, oil at an approaching volumetric capacity of the piston rod 13 going into the cylinder 12 passes through the compression side flow path 41A of the bottom piece 41 from the piston side chamber 12B so as to deflection deform and open the disc valve 42, and is pushed out to the reservoir chamber 12C, whereby a compression side damping force is obtained.

In this case, the hydraulic shock absorber 10 is provided with a rebound rubber 47 compression deformed when the piston rod 13 is extended (in a state of maximum extension of the hydraulic shock absorber 10), on a rebound seat 46 fixed to a side (a lower side) of the piston 24, around the piston rod 13 positioned in the rod side chamber 12A of the cylinder 12.

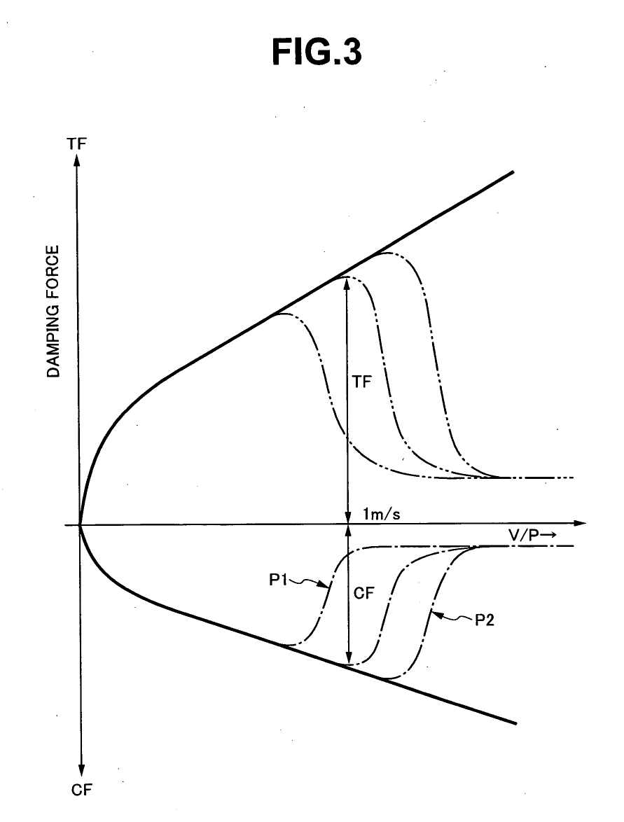

Accordingly, the hydraulic shock absorber 10 is provided with a compression side damping force adjusting apparatus 50 for adjusting a damping force of the piston valve apparatus 20, a compression side damping force in the present embodiment, in the following manner. In this case, in the piston valve apparatus 20 mentioned above, an expansion side damping force TF generated in the expansion side damping valve 33, and a compression side damping force CF generated in the compression side damping valve 34 change linearly approximately as shown by a solid line with respect to a piston moving speed V/P, as shown in FIG. 3. The compression side damping force adjusting apparatus 50 is structured such as to extremely lower the compression side damping force CF generated in the compression side damping valve 34 as shown by a one-dot chain line in FIG. 3, during periods of high damping force when the piston moving speed V/P reaches a fixed speed.

The compression side damping force adjusting apparatus 50 is provided with a compression side blow valve 60 blowing the oil liquid in the piston side chamber 12B pressurized during compression of the hydraulic shock absorber 10 to the rod side chamber 12A, in a bypass path 51 communicating the rod side chamber 12A with the piston side chamber 12B while bypassing the compression side damping valve 34, as shown in FIGS. 2A and 2B. In the present embodiment, the bypass path 51 is pierced in, or otherwise made a part of the piston rod 13.

The blow valve 60 is incorporated in the valve case 52 installed to an outer periphery of the piston rod 13 so as to be fixed. The valve case 52 is structured such that a hollow shaft 54 provided in a center portion of a tube box 53 in which both upper end lower ends are closed is installed to the outer periphery of the piston rod 13. The valve case 52 is provided with an inlet 52A communicating with the piston side chamber 12B via an opening 25A of a spacer 25 in a lower plate of the tube box 53, and is provided with an outlet 52B communicating with the bypass path 51 of the piston rod 13 in a hollow shaft 54. The blow valve 60 is formed as an annular body sliding with each of an inner periphery of the tube box 53 of the valve case 52 and an outer periphery of the hollow body 54 via a seal member in a liquid tight manner. The blow valve 60 is structured such that a lower end surface of the annular body is formed as a two-stage structure including a first pressure receiving portion 61 formed as a high step shape in an inner peripheral side and facing to the inlet 52A of the valve case 52, and a second pressure receiving portion 62 formed as a lower step shape than the first pressure receiving portion 61 in an outer periphery of the first pressure receiving portion 61. The blow valve 60 is structured such that a passage 63 is formed so as to pass through upper and lower sides of the annular body within the second pressure receiving portion 62. The passage 63 communicates a lower chamber 56A corresponding to a side communicating with the piston side chamber 12B, and an upper chamber 56B corresponding to a side communicating with the rod side chamber 12A during opening of the valve. The blow valve 60 is structured such that a valve spring 55 is interposed between an upper end surface of the annular body and a top plate of the tube box 53. An outer peripheral edge of the first pressure receiving portion 61 is brought into pressure contact with an open edge of the inlet 52A by a spring force of the valve spring 55, and the blow valve 60 is closed. Accordingly, the blow valve 60 receives the pressure of the piston side chamber 12B in the first pressure receiving portion 61 before the valve opening (during a period of valve closing) shown by a two-dot chain line in FIG. 2A, and after the valve opening shown by a solid line in FIG. 2A. The blow valve 60 also receives the pressure of the piston side chamber 12B in the second pressure receiving portion 62 in addition to the first pressure receiving portion 61 mentioned above, after the valve opening shown by the solid line in FIG. 2A. In this case, the blow valve 60 is provided with a passage 63A communicating with the outlet 52B of the valve case 52, in a boss portion provided in the upper end surface of the annular body sliding with the outer periphery of the hollow shaft 54 of the valve case 52.

The blow valve 60 is accessorily provided with a differential pressure generating means 57 lowering the pressure of the upper chamber 56B corresponding to the side communicating with the rod side chamber 12A with respect to the pressure of the lower chamber 56A corresponding to the side communicating with the piston side chamber 12B, after the valve opening. The differential pressure generating means 57 in accordance with the present embodiment is constructed by an orifice 58 constituted by a small hole 58B of a plate 58A fixedly provided in a lower end surface of the annular body to which the passage 63 of the blow valve 60 is open. The differential pressure generating means 57 makes the pressure of the upper chamber 56B lower than the pressure of the lower chamber 56A, on the basis of a throttle resistance loss which the orifice 58 applies to the oil liquid flowing to the upper chamber 56B through the orifice 58 from the lower chamber 56A via the passage 63 after opening the blow valve 60.

In this case, the differential pressure generating means 57 may be constructed by a variable orifice 59 which adjusts a flow path area of a small hole 59B of a plate 59A fixedly provided in the lower end surface of the annular body to which the passage 63 of the blow valve 60 is open, by a needle 59C provided in the annular body of the blow valve 60 so as to freely screw, as shown FIG. 2B.

Accordingly, the hydraulic shock absorber 10 is provided with the compression side damping force adjusting apparatus 50 and is actuated as follows.

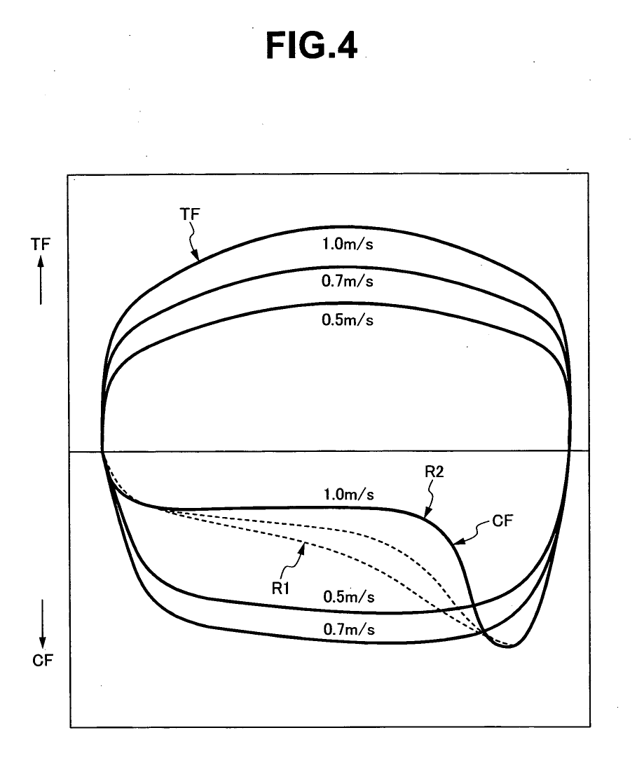

(1) If the piston moving speed V/P is increased and the pressure of the rod side chamber 12A or the piston side chamber 12B is increased in the expansion and contraction stroke of the hydraulic shock absorber 10, the expansion side damping valve 33 and the compression side damping valve 34 are opened, and the expansion side damping force TF and the compression side damping force CF shown by a solid line in FIG. 3 are generated. When the piston moving speed V/P is lower (for example, 0.5 m/s or 0.7 m/s) than a fixed speed (for example, 1.0 m/s), the damping forces TF and CF of the expansion side damping valve 33 and the compression side damping valve 34 do not generate any extreme descent in the strokes as shown in FIG. 4.

(2) If the piston moving speed V/P is further increased so as to reach a fixed speed in the compression stroke of the hydraulic shock absorber 10, and the pressure of the piston side chamber 12B is increased so as to reach a fixed pressure (a valve opening pressure of the blow valve 60), the blow valve 60 receives the pressure in the first pressure receiving portion 61 (a narrow pressure receiving surface) so as to be opened, and blows the high-pressure oil liquid of the piston side chamber 12B to the rod side chamber 12A via the lower chamber 56A of the valve case 52, the passage 63 of the blow valve 60, the upper chamber 56B of the valve case 52, the bypass path 51 and the like. Accordingly, the damping force CF of the compression side damping valve 34 is extremely lowered from the high damping force state as shown by a one-dot chain line in FIG. 3. FIG. 4 shows a fact that the damping force CF of the compression side damping valve 34 generates a substantial descent in the compression side stroke in which the piston moving speed V/P reaches, for example, 1.0 m/s.

(3) After the valve opening mentioned in the item (2) of the blow valve 60, the pressure of the piston side chamber 12B is lowered by blowing, however, the blow valve 60 receives the lowered pressure of the piston side chamber 12B by both (a wide pressure receiving surface) the first pressure receiving portion 61 and the second pressure receiving portion 62, so as to keep opening.

Further, after the valve opening mentioned in the item (2) of the blow valve 60, the differential pressure generating means 57 constituted by the orifice 58 lowers the pressure of the upper chamber 56B with respect to the pressure of the lower chamber 56A. The differential pressure between the lower chamber 56A and the upper chamber 56B keeps opening the blow valve 60.

Accordingly, if the hydraulic shock absorber 10 is rapidly compressed in the case that the wheels get over a step such as a curb or the like when the vehicle provided with the hydraulic shock absorber 10 goes into a parking or the like, for example, from a road, the compression side damping force is rapidly increased generally and the compression stroke becomes difficult to be carried out, so that a cloggy or rough ride quality is generated. In the present invention, if the compression side damping force is rapidly increased, the compression side blow valve 60 of the compression side damping force adjusting apparatus 50 is opened, and the damping force is significantly lowered so as to carry out a smooth compression stroke, thereby absorbing an impact applied to the wheels. Accordingly, the doggy or rough feeling is not generated, and it is possible to obtain such a ride quality as to lightly get over the step.

In accordance with the hydraulic shock absorber 10 in FIGS. 1, 2A and 2B, the following operations and effects can be obtained.

(a) The blow valve 60 blowing the oil liquid of the pressurized piston side chamber 12B to the rod side chamber 12A is provided in the bypass path 51 communicating the oil chamber 12A and the oil chamber 12B while bypassing the compression side damping valve 34. If the piston moving speed V/P reaches the fixed speed, and the pressure of the piston side chamber 12B reaches the valve opening pressure of the blow valve 60, the blow valve 60 is opened so as to blow the high-pressure oil liquid of the piston side chamber 12B to the rod side chamber 12A, and extremely lowers the damping force of the compression side damping valve 34 from the high damping force state.

Since the damping force characteristic is controlled while depending upon the pressure of the piston side chamber 12B, the expansion side damping valve 33 generates the normal damping force without relation to the compression blow valve 60. When the pressure of the piston side chamber 12B becomes higher, for example, in the compression stroke of the hydraulic shock absorber 10, the compression side blow valve 60 is opened so as to extremely lower the damping force of the compression side damping valve 34 from the high damping force state, and thereafter the stroke is inverted to the expansion stroke.

(b) The blow valve 60 has the first pressure receiving portion 61 capable of receiving the pressure of the piston side chamber 12B before and after opening the valve, and the second pressure receiving portion 62 capable of receiving the pressure of the piston side chamber 12B after opening the valve (two staged pressure receiving surface). Accordingly, the blow valve 60 receives the pressure of the piston side chamber 12B only by the first pressure receiving portion 61 (the narrow pressure receiving surface) until the pressure of the piston side chamber 12B reaches the valve opening pressure of the blow valve 60 so as to be opened. The valve opening pressure of the blow valve 60 is defined by the valve spring 55 and an area of the first pressure receiving portion 61. If the area of the first pressure receiving portion 61 is enlarged, the valve opening pressure becomes small, the blow valve 60 blows the pressure of the piston side chamber 12B in a lower stage, and lowers the damping force generated by the compression side damping valve 34. In a extremely lowered state of the compression side damping force CF of the compression side damping valve 34 shown in FIG. 3, reference symbol P1 denotes an example that the pressure receiving area of the first pressure receiving portion 61 is increased and the valve opening pressure is reduced, and reference symbol P2 denotes an example that the pressure receiving area of the first pressure receiving portion 61 is reduced and the valve opening pressure is increased.

After the blow valve 60 is opened, the pressure of the piston side chamber 12B is lowered by blowing, however, the blow valve 60 receives the lowered pressure of the piston side chamber 12B by the both (the wide pressure receiving surface) of the first pressure receiving portion 61 and the second pressure receiving portion 62 so as to keep opening. Accordingly, the blow valve 60 stably keeps opening (does not generate any unstable pulsation repeating opening and closing) after being once opened, thereby carrying on with the lowering of the damping force generated by the compression side damping valve 34.

(c) The blow valve 60 is provided with the differential pressure generating means 57 lowering the pressure in the side communicating with the rod side chamber 12A of the blow valve 60 with respect to the pressure in the side communicating with the piston side chamber 12B of the blow valve 60 after being opened. Even if the pressure of the piston side chamber 12B is further lowered than the item (b) mentioned above, it is possible to keep opening the blow valve 60 on the basis of the differential pressure.

(d) Since the blow valve 60 is provided in the compression side, it is possible to achieve the items (a) to (c) mentioned above compression of the hydraulic shock absorber 10.

(e) Since the blow valve 60 is provided in the bypass path 51 communicating the rod side chamber 12A and the piston side chamber 12B which are compartmentalized by the piston 24 provided in the piston rod 13 while bypassing the compression side damping valve 34, the items (a) to (c) mentioned above can be achieved by the piston valve apparatus 20.

(f) Since the differential pressure generating means 57 is constituted by the orifice 58, it is possible to generate the differential pressure by setting the throttle of the orifice 58, and it is possible to keep opening the blow valve 60. When the throttle of the orifice 58 is large in diameter, the generation of the differential pressure is small, thereby slowing the opening speed of the blow valve 60 and slowly lowering the damping force generated by the compression side damping valve 34 (a damping force characteristic R1 in FIG. 4). When the throttle of the orifice is small in diameter, the generation of the differential pressure is large, thereby quickening the opening speed of the blow valve 60 and quickly lowering the damping force generated by the compression side damping valve 34 (a damping force characteristic R2 in FIG. 4).

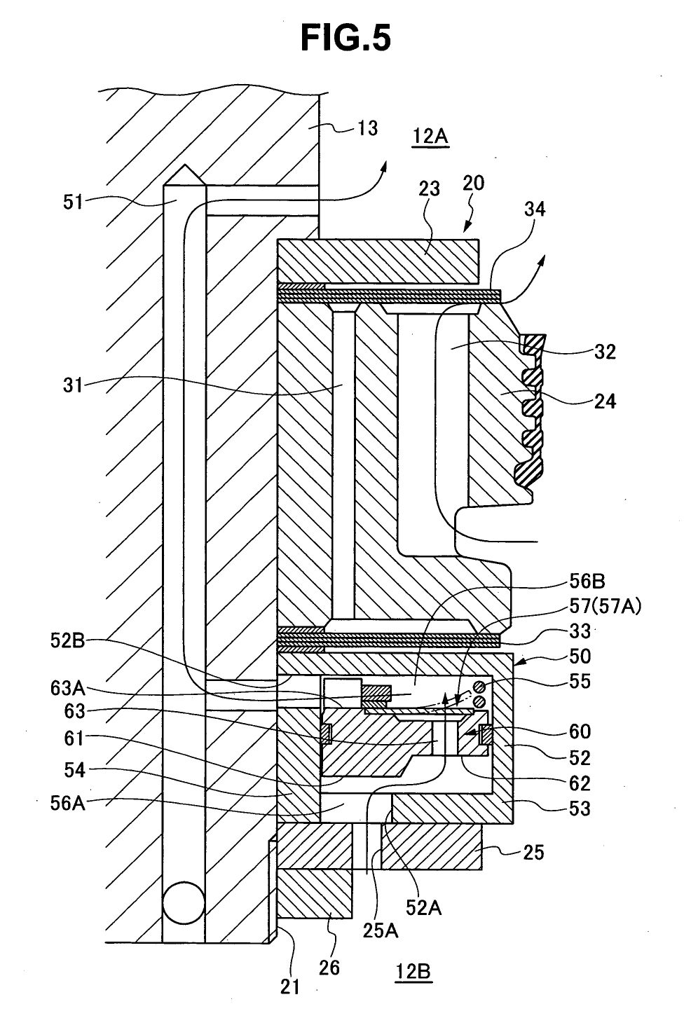

The hydraulic shock absorber 10 in FIG. 5 is different from the hydraulic shock absorber 10 in FIGS. 2A and 2B, wherein the differential pressure generating means 57 constructing the compression side damping force adjusting apparatus 50 is constituted by a plate valve 57A. The plate valve 57A is constituted by an annular plate additionally provided in the upper end surface of the annular body of the blow valve 60. The plate valve 57A fixes an annular center portion of the annular plate around a boss portion provided in an upper end surface of the annular body of the blow valve 60, and closes the passage 63 of the blow valve 60 by an annular portion in a deflection deformable outer peripheral side. The plate valve 57A makes the pressure of the upper chamber 56B lower than the pressure of the lower chamber 56A on the basis of a deflection resistance loss which the plate valve 57A applies to the oil liquid flowing to the upper chamber 56B from the lower chamber 56A via the passage 63 while deflection deforming the plate valve 57A after opening the blow valve 60.

In accordance with the hydraulic shock absorber 10 in FIG. 5, since the differential pressure generating means 50 is constituted by the plate valve 57A, it is possible to generate the differential pressure by setting a deflection rigidity of the plate valve 57A, and it is possible to keep opening the blow valve 60. When the deflection rigidity of the plate spring 57A is small, the generation of the differential pressure is small, the opening speed of the blow valve 60 is slowed and the damping force generated by the compression side damping valve 34 is slowly lowered. When the deflection rigidity of the plate valve 57A is large, the generation of the differential pressure is large, the opening speed of the blow valve 60 is quickened, and the damping force generated by the compression side damping valve 34 is quickly lowered.

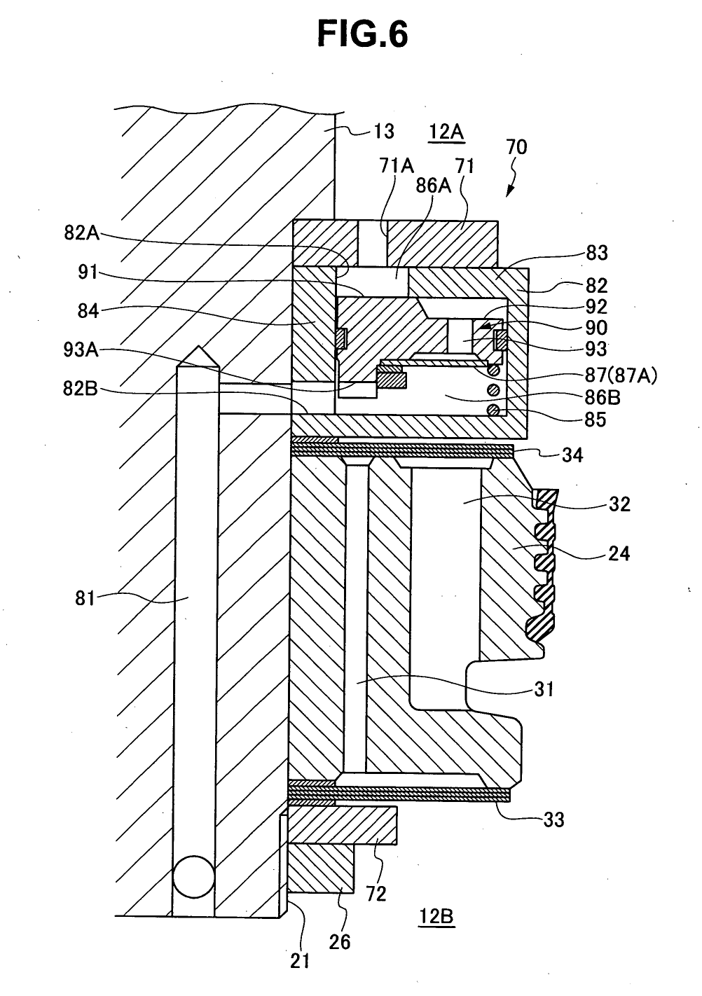

The hydraulic shock absorber 10 in FIG. 6 is structured such that the piston valve apparatus 20 is provided with an expansion side damping force adjusting apparatus 70 for adjusting the expansion side damping force. The expansion side damping force adjusting apparatus 70 is structured such as to extremely lower the expansion side damping force TF generated in the expansion side damping force valve 33 as shown by a two-dot chain line in FIG. 3 during high damping force periods when the piston moving speed V/P reaches a fixed speed. In this case, in the piston valve apparatus 20 of the hydraulic shock absorber 10, a spacer 71, a valve case 82 for a blow valve 90 mentioned below, the compression side damping valve 34, the piston 24, the expansion side damping valve 33 and a valve stopper 72 are installed to the outer periphery of the thread portion 21 of the piston rod 13, and they are pinched and fixed between the base end step portion of the thread portion 21 and the base end step portion by the nut 26 engaged with the thread portion 21.

The expansion side damping force adjusting apparatus 70 is provided with a expansion side blow valve 90 blowing the oil liquid in the rod side chamber 12A pressurized expansion of the hydraulic shock absorber 10 to the piston side chamber 12B, in a bypass path 81 communicating the rod side chamber 12A with the piston side chamber 12B while bypassing the expansion side damping valve 33, as shown in FIG. 6. In the present embodiment, the bypass path 81 is pierced or otherwise located in the piston rod 13.

The blow valve 90 is incorporated in the valve case 82 installed to an outer periphery of the piston rod 13 so as to be fixed. The valve case 82 is structured such that a hollow shaft 84 provided in a center portion of a tube box 83 in which both upper end lower ends are closed is installed to the outer periphery of the piston rod 13. The valve case 82 is provided with an inlet 82A communicating with the rod side chamber 12A via an opening 71A of a spacer 71 in an upper plate of the tube box 83, and is provided with an outlet 82B communicating with the bypass path 81 of the piston rod 13 in a hollow shaft 54. The blow valve 90 is formed as an annular body sliding with each of an inner periphery of the tube box 83 of the valve case 82 and an outer periphery of the hollow body 84 via a seal member in a liquid tight manner. The blow valve 90 is structured such that an upper end surface of the annular body is formed as a two-stage structure including a first pressure receiving portion 91 formed as a high step shape in an inner peripheral side and facing to the inlet 82A of the valve case 82, and a second pressure receiving portion 92 formed as a lower step shape than the first pressure receiving portion 91 in an outer periphery side of the first pressure receiving portion 91. The blow valve 90 is structured such that a passage 93 is formed so as to pass through upper and lower sides of the annular body within the second pressure receiving portion 92, the passage 93 communicating an upper chamber 86A corresponding to a side communicating with the rod side chamber 12A, and a lower chamber 86B corresponding to a side communicating with the piston side chamber 12B valve opening periods. The blow valve 90 is structured such that a valve spring 85 is interposed between a lower end surface of the annular body and a bottom plate of the tube box 83. An outer peripheral edge of the first pressure receiving portion 91 is brought into pressure contact with an open edge of the inlet 82A by a spring force of the valve spring 85, and the blow valve 60 is closed. Accordingly, the blow valve 90 receives the pressure of the rod side chamber 12A in the first pressure receiving portion 91 before and after opening (closing) the valve, and receives the pressure of the rod side chamber 12A in the second pressure receiving portion 92 after opening the valve. In this case, the blow valve 60 is provided with a passage 93A communicating with an outlet 82B of the valve case 82 in a boss portion provided in a lower end surface of an annular body sliding with an outer periphery of the hollow shaft 84 of the valve case 82.

The blow valve 90 is accessorily provided with a differential pressure generating means 87 lowering the pressure of the lower chamber 86B corresponding to the side communicating with the piston side chamber 12B with respect to the pressure of the upper chamber 86A corresponding to the side communicating with the rod side chamber 12A, after the valve opening. The differential pressure generating means 87 in accordance with the present embodiment is constructed by a plate valve 87A. The plate valve 87A is constituted by an annular plate additionally provided in a lower end surface of an annular body of the blow valve 90, fixes the annular center portion of the annular plate around the boss portion provided in the lower end surface of the annular body of the blow valve 90, and closes the passage 93 of the blow valve 90 by the annular portion in the deflection deformable outer peripheral side. The plate valve 87A makes the pressure of the lower chamber 86B lower than the pressure of the upper chamber 86A on the basis of a deflection resistance loss which the plate valve 87A applies to the oil liquid flowing to the lower chamber 86B from the upper chamber 86A via the passage 93 while deflection deforming the plate valve 87A after opening the blow valve 90.

Accordingly, the hydraulic shock absorber 10 is provided with the expansion side damping force adjusting apparatus 70 and is actuated as follows.

(1) If the piston moving speed V/P is increased and the pressure of the rod side chamber 12A or the piston side chamber 12B is increased in the expansion and contraction stroke of the hydraulic shock absorber 10, the expansion side damping valve 33 and the compression side damping valve 34 are opened, and the expansion side damping force TF and the compression side damping force CF shown by a solid line in FIG. 3 are generated. When the piston moving speed V/P is lower (for example, 0.5 m/s or 0.7 m/s) than a fixed speed (for example, 1.0 m/s), the damping forces TF and CF of the expansion side damping valve 33 and the compression side damping valve 34 do not generate any substantial descent in the strokes as shown in FIG. 4.

(2) If the piston moving speed V/P is further increased so as to reach a fixed speed in the expansion stroke of the hydraulic shock absorber 10, and the pressure of the rod side chamber 12A is increased so as to reach a fixed pressure (a valve opening pressure of the blow valve 90), the blow valve 90 receives the pressure in the first pressure receiving portion 91 (a narrow pressure receiving surface) so as to be opened, and blows the high-pressure oil liquid of the rod side chamber 12A to the piston side chamber 12B via the upper chamber 86A of the valve case 82, the passage 93 of the blow valve 90, the lower chamber 86B of the valve case 82, the bypass path 81 and the like. Accordingly, the damping force TF of the expansion side damping valve 33 is extremely lowered from the high damping force state as shown by a two-dot chain line in FIG. 3.

(3) After the valve opening mentioned in item (2) of the blow valve 90, the pressure of the rod side chamber 12A is lowered by blowing, however, the blow valve 90 receives the lowered pressure of the rod side chamber 12A by both (a wide pressure receiving surface) the first pressure receiving portion 91 and the second pressure receiving portion 92 so as to keep opening.

Further, after the valve opening mentioned in the item (2) of the blow valve 90, the differential pressure generating means 87 constituted by the plate valve 87A lowers the pressure of the lower chamber 86B with respect to the pressure of the upper chamber 86A. The differential pressure between the upper chamber 86A and the lower chamber 86B keeps opening the blow valve 90.

In accordance with the hydraulic shock absorber 10 in FIG. 6, the following operations and effects can be achieved.

(a) The blow valve 90 blowing the oil liquid of the pressurized rod side chamber 12A to the piston side chamber 12B is provided in the bypass path 81 communicating the oil chamber 12A and the oil chamber 12B while bypassing the expansion side damping valve 33. If the piston moving speed V/P reaches the fixed speed, and the pressure of the rod side chamber 12A comes to the valve opening pressure of the blow valve 90, the blow valve 90 is opened so as to blow the high-pressure oil liquid of the rod side chamber 12A to the piston side chamber 12B, and extremely lowers the damping force of the expansion side damping valve 33 from the high damping force state.

Since the damping force characteristic is controlled while depending upon the pressure of the rod side chamber 12A, the compression side damping valve 34 generates the normal damping force without relation to the expansion blow valve 90. During a period when the pressure of the rod side chamber 12A becomes higher, for example, in the expansion stroke of the hydraulic shock absorber 10, the expansion side blow valve 90 is opened so as to extremely lower the damping force of the expansion side damping valve 33 from the high damping force state, and thereafter the stroke is inverted to the compression stroke.

(b) The blow valve 90 has the first pressure receiving portion 91 capable of receiving the pressure of the rod side chamber 12A before and after opening the valve, and the second pressure receiving portion 92 capable of receiving the pressure of the rod side chamber 12A after opening the valve (two staged pressure receiving surface). Accordingly, the blow valve 90 receives the pressure of the rod side chamber 12A only by the first pressure receiving portion 91 (the narrow pressure receiving surface) until the pressure of the rod side chamber 12A reaches the valve opening pressure of the blow valve 90 so as to be opened. The valve opening pressure of the blow valve 90 is defined by the valve spring 85 and an area of the first pressure receiving portion 91. If the area of the first pressure receiving portion 91 is enlarged, the valve opening pressure becomes small, the blow valve 60 blows the pressure of the rod side chamber 12A in a lower stage, and lowers the damping force generated by the expansion side damping valve 33.

After the blow valve 90 is opened, the pressure of the rod side chamber 12A is lowered by blowing, however, the blow valve 90 receives the lowered pressure of the rod side chamber 12A by the both (the wide pressure receiving surface) of the first pressure receiving portion 91 and the second pressure receiving portion 92 so as to keep opening. Accordingly, the blow valve 90 stably keeps opening (does not generate any unstable pulsation repeating opening and closing) after being once opened, thereby carrying on with the lowering of the damping force generated by the expansion side damping valve 33.

(c) The blow valve 90 is provided with the differential pressure generating means 87 lowering the pressure in the side communicating with the piston side chamber 12B of the blow valve 90 with respect to the pressure in the side communicating with the rod side chamber 12A of the blow valve 90 after being opened. Even if the pressure of the rod side chamber 12A is further lowered than the item (b) mentioned above, it is possible to keep opening the blow valve 90 on the basis of the differential pressure.

(d) Since the blow valve 90 is provided in the expansion side, it is possible to achieve the items (a) to (c) mentioned above during expansion of the hydraulic shock absorber 10.

(e) Since the blow valve 90 is provided in the bypass path 81 communicating the rod side chamber and the piston side chamber which are compartmentalized by the piston 24 provided in the piston rod 13 while bypassing the expansion side damping valve 33, the items (a) to (c) mentioned above can be achieved by the piston valve apparatus 20.

(f) Since the differential pressure generating means 87 is constituted by the plate valve 87A, it is possible to generate the differential pressure by setting the deflection rigidity of the plate valve 87A, and it is possible to keep opening the blow valve 90. When the deflection rigidity of the plate valve 87A is small, the generation of the differential pressure is small, the opening speed of the blow valve 90 is made slow, and the damping force generated by the expansion side damping valve 33 is lowered slowly. When the deflection rigidity of the plate valve 87A is large, the generation of the differential pressure is large, the opening speed of the blow valve 90 is made quick, and the damping force generated by the expansion side damping valve 33 is lowered quickly.

As heretofore explained, embodiments of the present invention have been described in detail with reference to the drawings. However, the specific configurations of the present invention are not limited to the embodiments but those having a modification of the design within the range of the present invention are also included in the present invention. For example, the damping force adjusting structure in accordance with the present invention may be provided both the compression side blow valve 60 blowing during compression of the hydraulic shock absorber 10, and the expansion side blow valve 90 blowing during expansion of hydraulic shock absorber 10.

Further, the damping force adjusting structure in accordance with the present invention may be structured such that the blow valve is provided in the bypass path communicating the piston side chamber 12B and the reservoir chamber 12C which are compartmentalized by the bottom piece 41 provided in the lower end of the cylinder 12, while bypassing the damping valve 42.

Further, the damping force adjusting structure in accordance with the preset invention can carry out a frequency depending type damping force adjustment in correspondence to the frequency of the piston moving speed V/P, by setting the orifice in the inlet of the blow valve (the inlet 52A of the valve case 52, the opening 25A of the spacer 25 or the like for the blow valve 60, or the inlet 82A of the valve case 82, the opening 71A of the space 71 or the like for the blow valve 90). Further, it is possible to set it such that the blow valve is not actuated during a period of high frequency of the piston moving speed V/P.

Further, since the damping force adjusting structure in accordance with the present invention lowers the damping force of the hydraulic shock absorber if a fixed or large impact is applied to the wheel, the damping force adjusting structure can be employed as an impact force unit apparatus.

Although the invention has been illustrated and described with respect to several exemplary embodiments thereof, it should be understood by those skilled in the art that the foregoing and various other changes, omissions and additions may be made to the present invention without departing from the spirit and scope thereof Therefore, the present invention should not be understood as limited to the specific embodiment set out above, but should be understood to include all possible embodiments which can be embodied within a scope encompassed and equivalents thereof with respect to the features set out in the appended claims.

What is claimed is:

1. A damping force adjusting structure of a hydraulic shock absorber comprising an oil chamber of a cylinder accommodating an oil fluid/liquid therein, a piston slidably fitted and inserted to the cylinder, provided in an insertion end of a piston rod inserted to the cylinder, and a damping valve to control flow of an oil fluid/liquid from one oil chamber to the other oil chamber pressurized by a sliding motion of the piston so as to generate a damping force,
a blow valve for blowing the oil fluid/liquid in the pressurized one oil chamber to the other oil chamber is provided in a bypass path communicating said both oil chambers while bypassing the damping valve,
the blow valve having a first pressure receiving portion capable of receiving the pressure of the one oil chamber before and after the valve opening, and a second pressure receiving portion capable of receiving the pressure of the one oil chamber after the valve opening, and
wherein the blow valve is provided with a differential pressure generating means lowering a pressure in a side communicating with the other oil chamber of said blow valve with respect to a pressure in a side communicating with the one oil chamber of said blow valve after the valve opening.

2. A damping force adjusting structure of a hydraulic shock absorber according to claim 1, wherein said blow valve comprises a compression side blow valve blowing during a period when the hydraulic shock absorber is compressed, and/or an expansion side blow valve blowing at a time when the hydraulic shock absorber is expanded.

3. A damping force adjusting structure of a hydraulic shock absorber as claimed in claim 1, wherein said blow valve is provided in a bypass path communicating a rod side chamber and a piston side chamber which are compartmentalized by the piston provided in the piston rod, while bypassing the damping valve.

4. A damping force adjusting structure of a hydraulic shock absorber as claimed in claim 2, wherein said blow valve is provided in a bypass path communicating a rod side chamber and a piston side chamber which are compartmentalized by the piston provided in the piston rod, while bypassing the damping valve.

5. A damping force adjusting structure of a hydraulic shock absorber according to claim 1, wherein said blow valve is provided in a bypass path communicating a piston side chamber and a reservoir chamber which are compartmentalized by a bottom piece provided in a lower end portion of the cylinder, while bypassing the damping valve.

6. A damping force adjusting structure of a hydraulic shock absorber according to claim 2, wherein said blow valve is provided in a bypass path communicating a piston side chamber and a reservoir chamber which are compartmentalized by a bottom piece provided in a lower end portion of the cylinder, while bypassing the damping valve.

7. A damping force adjusting structure of a hydraulic shock absorber according to claim 1, wherein said differential pressure generating means comprises an orifice.

8. A damping force adjusting structure of a hydraulic shock absorber according to claim 2, wherein said differential pressure generating means comprises an orifice.

9. A damping force adjusting structure of a hydraulic shock absorber according to claim 3, wherein said differential pressure generating means comprises an orifice.

10. A damping force adjusting structure of a hydraulic shock absorber according to claim 4, wherein said differential pressure generating means comprises an orifice.

11. A damping force adjusting structure of a hydraulic shock absorber according to claim 1, wherein said differential pressure generating means comprises a plate valve.

12. A damping force adjusting structure of a hydraulic shock absorber according to claim 2, wherein said differential pressure generating means comprises a plate valve.

13. A damping force adjusting structure of a hydraulic shock absorber according to claim 3, wherein said differential pressure generating means comprises a plate valve.

14. A damping force adjusting structure of a hydraulic shock absorber according to claim 4, wherein said differential pressure generating means comprises a plate valve.

15. A damping force adjusting structure of a hydraulic shock absorber according to claim 1, said blow valve being incorporated in a valve case installed to an outer periphery of said piston rod so as to be fixed, and
wherein said valve case is structured such that a hollow shaft provided in a center portion of a tube box in which both upper and lower ends are closed is installed to an outer periphery of the piston rod, an inlet communicating with the one oil chamber is provided in the tube box, and an outlet communicating with the other oil chamber via the bypass path of said piston rod is provided in the hollow shaft.

16. A damping force adjusting structure of a hydraulic shock absorber according to claim 2, said blow valve being incorporated in a valve case installed to an outer periphery of said piston rod so as to be fixed, and
wherein said valve case is structured such that a hollow shaft provided in a center portion of a tube box in which both upper and lower ends are closed is installed to an outer periphery of the piston rod, an inlet communicating with the one oil chamber is provided in the tube box, and an outlet communicating with the other oil chamber via the bypass path of said piston rod is provided in the hollow shaft.

17. A damping force adjusting structure of a hydraulic shock absorber according to claim 15, wherein said blow valve forms an annular body sliding in a liquid tight manner with each of an inner periphery of the tube box of said valve case, and an outer periphery of said hollow shaft.

18. A damping force adjusting structure of a hydraulic shock absorber according to claim 16, wherein said blow valve forms an annular body sliding in a liquid tight manner with each of an inner periphery of the tube box of said valve case, and an outer periphery of said hollow shaft.

19. A damping force adjusting structure of a hydraulic shock absorber according to claim 17, said first pressure receiving portion faces to the inlet of said valve case while forming an end surface of said annular body as a high step shape in an inner peripheral side, and
wherein said second pressure receiving portion is formed as a lower step shape than the first pressure receiving portion in an outer periphery of said first pressure receiving portion.

20. A damping force adjusting structure of a hydraulic shock absorber according to claim 18, said first pressure receiving portion faces to the inlet of said valve case while forming an end surface of said annular body as a high step shape in an inner peripheral side, and
wherein said second pressure receiving portion is formed as a lower step shape than the first pressure receiving portion in an outer periphery of said first pressure receiving portion.

21. A damping force adjusting structure of a hydraulic shock absorber according to claim 5, wherein said hydraulic shock absorber is of a double tube type comprising a double tube in which said cylinder is incorporated in the damper tube, and a gap between said damper tube and the cylinder is formed as said reservoir chamber.

22. A damping force adjusting structure of a hydraulic shock absorber according to claim 6, wherein said hydraulic shock absorber is of a double tube type comprising a double tube in which said cylinder is incorporated in the damper tube, and a gap between said damper tube and the cylinder is formed as said reservoir chamber.
